(19) United States
(12) Patent Application Publication
(10) Pub. No.: US 2002/0093461 A1
(43) Pub. Date: Jul. 18, 2002

(54) Outdoor display and information system

(75) Inventor: Anthony Sam, San Francisco, CA (US)

Correspondence Address: Michael E. Woods, Patent Law Offices of Michael E. Woods, 104 Collins Street, San Francisco, CA, 94118, US

(73) Assignee: Xtronx, Inc., San Francisco, CA

(21) Appl. No.: 10/001,236

(22) Filed: Oct. 31, 2001

Related U.S. Application Data
(60) Provisional application No. 60/246,791, filed on Nov. 8, 2000.

(51) Int. Cl. G09G 5/00

(52) U.S. Cl. 345/1.1

(57) ABSTRACT

A preferred embodiment of the present invention is an information display system that includes a commercial zoned building having a plurality of floors spaced a first distance apart, the building disposed proximate an audience target area and having an audience exposure portal in an exterior wall of the building targeting said target area. The system further includes an information presentation apparatus, having a height greater than the first distance, disposed inside a display containment zone within the building and proximate the portal wherein information from the information presentation apparatus is provided to the target area through the portal. An alternate preferred embodiment addresses a display retrofit method that includes creating a display containment zone within a commercial zoned building proximate and audience target area, the building having a plurality of floors spaced a first distance apart, the building disposed proximate an audience target area and having an audience exposure portal in an exterior wall of the building targeting the target area wherein the display containment zone spans at least two floors of the plurality of floors and includes an audience exposure portal in an exterior wall of the building targeting the target area; mounting an information presentation apparatus, having a height greater than the first distance, within the display containment zone; and altering the exterior wall of the building such that the exposure portal is substantially visually-non-impairing for the audience target area.

### CROSS-REFERENCES TO RELATED APPLICATIONS

This application claims priority of provisional of application Ser. No. 60/246,791, filed Nov. 8, 2000, which is incorporated herein by reference for all purposes.

### BACKGROUND OF THE INVENTION

The present invention relates generally to information presentation systems, and relates more specifically to massively large-scale displays for providing information to large numbers of people.

It is known in the art to provide a large-scale display generically referred to as a jumbotron at various locations where large numbers of people gather or pass by. Times Square in New York City has a very famous jumbotron. At the time of filing this priority application, the operators of the New York Times Square jumbotron represent statistics for that jumbotron that includes: about 1.5 million daily viewers, 27 million tourist visits, 4 million overnight visitors, 12,600 nearby hotel rooms, 40 nearby Broadway theaters, 250 nearby restaurants. Jumbotrons are used at other highly populated venues, and are very effective at capturing the attention of any nearby viewers.

These large outdoor displays are so effective in fact, that various government entities have passed laws and ordinances limiting and controlling outdoor displays. It is desirable to provide suitable displays to large viewing audiences while complying with all applicable laws.

It is a further disadvantage of large outdoor displays that they have greater costs associated with them due to expenses of weather-proofing and maintenance. It is desirable to provide a lower cost display solution that provides the same advantages as a conventional jumbotron.

Yet still another disadvantage of conventional display systems is that information is typically presented in a single format: visual. Such conventional systems are thus ineffective at presenting information to users who are unable to see the display for any number of reasons.

Other disadvantages of conventional display systems include a relatively high cost for insurance, a significant risk of vandalism as components are largely unsecured, weather (e.g., snow) is able to adversely affect the visibility of the display, construction costs include costs associated with design/engineering/construction of ancillary components and structural needs, and a reduced longevity of the display system/screen components because of the exposure to varying temperatures and inability to control the dew point.

FIG. 1 is a view of a conventional display system 100 including a large-scale visual display 105 mounted atop a building 110 in conventional fashion. Building 105 includes a succession of stacked floors 115, each conventionally adapted to facilitate the functions of the building. As is typical, floors 115 are spaced periodically (e.g., every 10-14 feet) and include a plurality of windows 120 adapted to provide light and scenic information to occupants of building 110. As described above, the placement of display 105 on the exterior roof of building 110 has disadvantages in that the display may block visual sight lines of neighbors, the placement of display 105 may be controlled or limited by various federal, state and local laws. In operation, dynamic visual information (sometimes static information) is presented on display 105. Viewers in the vicinity of building 110 and having a line of sight to display 105 are served by the conventional information display system shown in FIG. 1.

### SUMMARY OF THE INVENTION

The present invention provides a simple efficient solution to the disadvantages of the prior art. A large-scale visual, audio and data information presentation system according to a preferred embodiment of the present invention provides for construction and placement and orientation of special large-scale indoor displays to be viewable and/or accessible from outside, as well as retrofit and renovation of existing building or structures to accommodate such indoor displays.

A preferred embodiment of the present invention is an information display system that includes a commercial zoned building having a plurality of floors spaced a first distance apart, the building disposed proximate an audience target area and having an audience exposure portal in an exterior wall of the building targeting said target area. The system further includes an information presentation apparatus, having a height greater than the first distance, disposed inside a display containment zone within the building and proximate the portal wherein information from the information presentation apparatus is provided to the target area through the portal.

An alternate preferred embodiment addresses a display retrofit method that includes creating a display containment zone within a commercial zoned building proximate and audience target area, the building having a plurality of floors spaced a first distance apart, the building disposed proximate an audience target area and having an audience exposure portal in an exterior wall of the building targeting the target area wherein the display containment zone spans at least two floors of the plurality of floors and includes an audience exposure portal in an exterior wall of the building targeting the target area; mounting an information presentation apparatus, having a height greater than the first distance, within the display containment zone; and altering the exterior wall of the building such that the exposure portal is substantially visually-non-impairing for the audience target area.

Further understanding of the nature and advantages of the invention may be realized by reference to the remaining portions of the Specification and Drawings. In the drawings, similarly numbered items represent the same or functionally equivalent structures.

### BRIEF DESCRIPTION OF THE DRAWINGS

FIG. 1 is a conventional view of a large-scale visual display mounted atop a building in conventional fashion;

FIG. 2 is a view of a preferred embodiment of the present invention in which a building has been modified to enable a large-scale visual display to be mounted inside existing floors;

FIG. 3 is a view of an alternate preferred embodiment of the present invention in which a building has been modified to enable a large-scale visual display to be enclosed inside a new structure of the building; and

FIG. 4 is a side view of the alternate preferred embodiment illustrated in FIG. 3.

### DESCRIPTION OF THE SPECIFIC EMBODIMENTS

FIG. 2 is a view of a preferred embodiment of the present invention for an information presentation system 200. Information presentation system 200 includes a building 205 adapted to suitably house one or more visual displays 210, and an antenna 215 or other data transmission mechanism.

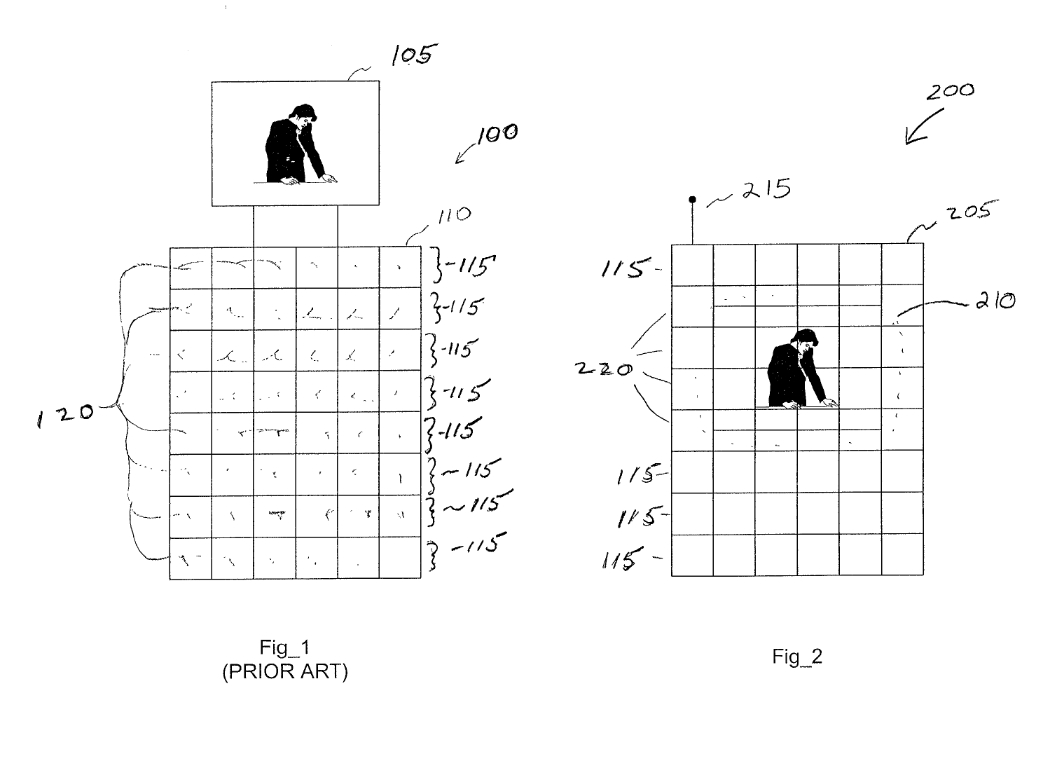

Building 205 is similar to building 110 shown in FIG. 1, except that selected floors 220 have been modified to permit display 210 to be placed inside building 205. Display 210 is preferably positioned proximate the exterior windows. In some applications, display 210 may be positioned closer or further than these preferred specifications, depending upon the design parameters. In some cases, display 210 may be oriented other than normal to the x-y-z axes defined by the walls of building 205. Display 210 may be tilted, rotated, translated to achieve optimum viewability for the expected majority of the viewing audience.

In a still more preferred embodiment, exterior windows of building 205 disposed between display 210 and the viewing audience are replaced with windows that minimize any distortion or attenuation of the visual image presented on display 210. Some configurations may include a single panel sized similarly to display 210, or may include an array of panels. The replacement window or windows could be selected to blend into the existing window pattern, or be designed to highlight the presence of display 210, depending upon user configuration.

Information presentation system 200 includes antenna 215. Antenna 215 actually represents a transmission mechanism for issuing information or data in synchronization with or complementary to or related to the information concurrently being presented on display 210. For example, antenna 215 may be an FM RF transmitter that includes audio information in synchronization with the image of display 215. Similarly, antenna 215 may be an infrared transmitter sending personal computer (PC) or personal digital assistant (PDA) formatted data relating in some fashion to the image on display 210. In other implementations, the transmissions may be ultrasonic signals or other information or data transmission systems.

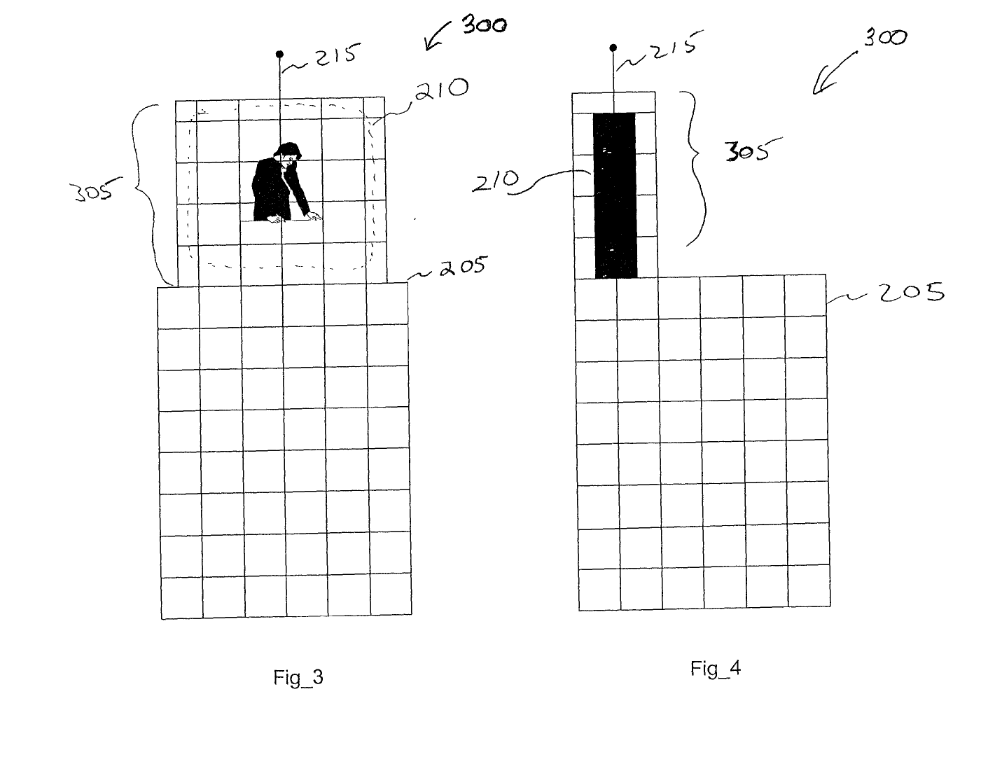

FIG. 3 is a view of an alternate preferred embodiment of the present invention for an alternate information presentation system 300 in which building 205 has been modified to enable display 210 to be enclosed inside a new structure 305 added on top of the roof of building 205. Structure 305 may be sized closely to display 210, or may be otherwise sized for aesthetic conformance with regard to existing building 205. FIG. 4 is a side view of alternate presentation system 300 illustrating that structure 305 may be sized to match display 210. It is preferrable to provide sufficient space for operation and maintenance of display 210, but in some configurations access may be achieved by opening access portals on structure 305 (not shown).

A preferred embodiment of the present invention is an information display system that includes a commercial zoned building having a plurality of floors spaced a first distance apart, the building disposed proximate an audience target area (which may be several hundreds of feet away from the building and preferrably includes a gathering place or path having many hundreds or thousands of people a day) and having an audience exposure portal in an exterior wall of the building targeting said target area. The portal is made substantially visually-nonimpairing as determined by the distance from the communication apparatus to the audience target area. (In some lesser preferred embodiments and depending upon varioius environmental factors of the location where the building is located, display containment zone may have an open, exposed area created in the exterior wall which will adequately protect the building from the weather and possible vandalism.) The system further includes an information presentation apparatus, having a height greater than the first distance, disposed inside the display containment zone within the building and proximate the portal wherein information from the information presentation apparatus is provided to the target area through the portal. The display containment zone may further provide for environmental, physical and structural support for the display apparatus under different conditions than the controls for the people-occupied portions of the building or the floors including the display containment zone.

An enhancement to these embodiments includes provision to persons at or near the target audience area or the buidling of synchronized/related audio/data with respect to the image(s) on the display presentation apparatus. This synchronization may be achieved with transmitters mounted on/within/near the building or the target audience area. The transmission medium may include RF, IR, Accoustic, Optic or any other audio/data communication mechanism. These signals are received by individual members of the target audience by standard AM/FM radios, by personal data assistants (PDAs) or wireless reception to other handheld electronic devices. Further, the transmissions may have several concurrent channels, with, for example, audio on one or more channels (possibly in several different languages) and data (relating to the presentation or related topics) on other channels. A user is able to select what audio/data channel is preferred.

An alternate preferred embodiment addresses a display retrofit method that includes creating a display containment zone within a commercial zoned building proximate and audience target area, the building having a plurality of floors spaced a first distance apart, the building disposed proximate an audience target area and having an audience exposure portal in an exterior wall of the building targeting the target area wherein the display containment zone spans at least two floors of the plurality of floors and includes an audience exposure portal in an exterior wall of the building targeting the target area; mounting an information presentation apparatus, having a height greater than the first distance, within the display containment zone; and altering the exterior wall of the building such that the exposure portal is substantially visually-non-impairing for the audience target area.

In the foregoing specification, the invention has been described with reference to a specific exemplary embodiments thereof. It will, however, be evident that various modifications and changes may be made thereunto without departing from the broader spirit and scope of the invention as set forth in the claims.

Many changes or modifications are readily envisioned, for example, changing the shape of the slot and the shape of the head portion, adding catches to the engagement members, and changing the shape of the flanges among other changes. The specification and drawings are, accordingly, to be regarded in an illustrative rather than in a restrictive sense.

What is claimed is:

1. An information display system, comprising:
a commercial zoned building having a plurality of floors spaced a first distance apart, said building disposed proximate an audience target area and having an audience exposure portal in an exterior wall of said building targeting said target area; and
an information presentation apparatus, having a height greater than said first distance, disposed inside a display containment zone within said building and proximate said portal wherein information from said information presentation apparatus is provided to said target area through said portal.

2. A display retrofit method, comprising:
creating a display containment zone within a commercial zoned building proximate and audience target area, said building having a plurality of floors spaced a first distance apart, said building disposed proximate an audience target area and having an audience exposure portal in an exterior wall of said building targeting said target area wherein said display containment zone spans at least two floors of said plurality of floors and includes an audience exposure portal in an exterior wall of said building targeting said target area;
mounting an information presentation apparatus, having a height greater than said first distance, within said display containment zone; and
altering said exterior wall of said building such that said exposure portal is substantially visually-non-impairing for said audience target area.
